(19) United States
(12) Patent Application Publication
(10) Pub. No.: US 2026/0013491 A1
(43) Pub. Date: Jan. 15, 2026

(54) APPLICATOR, SYSTEM AND METHOD FOR APPLYING ELECTRICAL CURRENT INTO A PLANT, AND AGRICULTURAL PIVOT

(71) Applicants: Zasso Group AG, Zug (CH); Zasso Brasil Indústria e Comércio de Máquinas Ltda., Indaiatuba, SP (BR)

(72) Inventors: Sergio de Andrade COUTINHO FILHO, Indaiatuba, SP (BR); Guilherme Penna Moreira RINZLER, São Paulo, SP (BR)

(73) Assignees: Zasso Group AG, Zug (CH); Zasso Brasil Indústria e Comércio de Máquinas Ltda., Indaiatuba, SP (BR)

(21) Appl. No.: 18/996,004

(22) PCT Filed: Oct. 20, 2022
(86) PCT No.: PCT/BR2022/050406

§ 371 Date: Jan. 17, 2025

(51) Int. Cl. A01M 21/04

(52) U.S. Cl. CPC A01M 21/046

(57) ABSTRACT

The present invention refers to an applicator for applying electrical current into a plant, the applicator being connected to an electrical power source, the applicator comprising: an image sensor configured to capture image data of the area to be treated and connected to a processor configured to perform a detection method for detecting an undesired plant; an electrode for applying electrical current by contacting the undesired plant; and a vertical mover configured to vertically move the electrode; wherein, when an undesired plant is detected, the horizontal mover moves the applicator horizontally above the undesired plant and/or the vertical mover moves the electrode toward the undesired plant. The present invention also refers to a system, an agricultural pivot and method for applying electrical current into a plant.

### FIELD OF THE DISCLOSURE

The present invention relates to an electrical current applicator for the application of electricity into plants comprising an image sensor and a mover for moving an electrode upon detection of undesired plants in crops such as weeds. More specifically, the invention refers to an electrical weeding applicator device that can be used in structures of crop fields such as agricultural pivots.

### DESCRIPTION OF THE RELATED ART

In the field of agricultural industry, it is commonly known that undesired organisms can be killed or eradicated with the use of electrical weeding applicator devices. In some applications, the electrical energy can be applied to kill or desiccate weeds. Alternatively, the electrical energy can be applied to control or diminish root borne organisms.

Some known techniques, like the one of document U.S. Pat. No. 4,007,794A, proposes the application of electricity to plants, specifically presenting a desiccation technique for applying high voltage to the above-ground growth of root crops.

Document AU2017366640A1 relates to a device and a method for introducing a high voltage into a substrate comprising biological material, in which an applicator module having two or more applicators with simultaneously differing polarities is used through which the metered electrical high voltage flows so as to alter the substrate. Different embodiments allow the high voltage to be controlled and introduced in a targeted manner into the substrate.

To that end, different arrangements can be used. For instance, document WO2015119523A1 discloses an apparatus for destroying weeds, which consists of a switch transformer, cascade assembly for the voltage multiplication, and high voltage transformer and a feedback assembly, assembled in a whole so that input connector is attached to switch, output connector of which is attached to one input connector of the transformer's primary, whose other primary end is connected to input connector, while the output connectors of transformer's secondary are connected to input connectors of cascade assembly whose output is connected to one input connector of the high-voltage transformer's primary, whilst the cascade assembly is through feedback assembly connected to the second input connector of the high-voltage transformer's primary, whereas the connectors of the high-voltage transformer's secondary are connected to the electrodes which produce a strong electromagnetic field.

However, in such techniques, the applicators must be moved toward the plants and eventually contacting the undesired plants.

In some other weeding techniques, including mechanical or chemical weeding devices, it is proposed the use of sensors for mapping the area to be treated, detecting the undesired organisms, and applying the adequate weeding operations.

Document U.S. Pat. No. 10,548,306B2 discloses a device for damaging uncultivated plants, comprising a tool which is designed to damage the uncultivated plants and a classification unit representing positional data of the uncultivated plants and/or designed to recognize uncultivated plants. The classification unit has the positional data of the weed available, especially in the form of a map, and/or if it detects the weed with the aid of a camera unit and/or a laser unit. This measure makes it possible to further increase the precision of the weed-control process.

Document WO2017002093A1 refers to a method of using a robot for an automatic treatment of a weed, by capturing images of weeds with a camera on said robot; determining with said images a distance between the weed and a second vegetable organism; and selecting a treatment tool of said robot for a treatment of the weed based on the determined distance. Document WO2017002093A1 describes a computer vision system as part of the processing system that processes the successive images captured with the camera and determines the distance between the vegetable organisms. The computer vision system can identify the specie of the vegetable organism on the surface and map their position in the field, permitting an accurate treatment of the vegetable organism.

Document WO2021069980A1 relates to a robotic weeding equipment for an agriculture robotic weeding system, comprising a plant squeezer for squeezing cultivated plants and an image recognition device for identification of weeds; and a weed treatment processing device. Thus, WO2021069980A1 discloses an image recognition device that is capable of identifying weeds which may be located near the base of each rows of cultivated plants since their leaves are moved away from the field of vision of the image recognition device by respective longitudinal sides of the plant squeezer and weed treatment may be selected to eradicate the weeds.

Document US20170251589A1 discloses a farming system including a field engagement unit having a support assembly, most specifically, it discloses an agricultural pivot comprising several attachments for different purposes. The support assembly includes one or more work tool rail assemblies. The farming system additionally includes a local controller. The local controller includes one or more processors configured to execute a set of program instructions stored in memory. In addition, US20170251589A1 describes the use of vision systems to capture image of crops comprising crop features. In addition, the one or one crop features captured may be used for identifying the weed and proactively guiding a mechanical weeding and/or herbicide-spraying attachment. According to US20170251589A1, some of the attachments may be configured to mechanically weed around specific plants and/or regions of the field based on processed imaging recommendations.

Therefore, the state of the art comprises some techniques that can be applied for weeding with the aid of image identification. In addition, the prior art presents some techniques for applying electrical energy into plants for controlling or killing unwanted organisms.

However, the prior art does not comprise a solution that provides a device that can be efficiently moved and used for applying electrical energy into undesired plants. In addition, the solutions of the state of the art does not present a simple system that can be implemented on crop fields or installed in a practical manner on equipment that is already used for other purposes, such as agricultural pivots.

### SUMMARY OF THE INVENTION

The present invention provides an applicator for applying electrical current into a plant, the applicator being connected to an electrical power source, the applicator comprising: an image sensor configured to capture image data of an area to be treated and connected to a processor configured to perform a detection method for detecting an undesired plant; an electrode for applying electrical current by contacting the undesired plant; and a vertical mover configured to vertically move the electrode; wherein, when an undesired plant is detected, the horizontal mover moves the applicator horizontally above the undesired plant and/or the vertical mover moves the electrode toward the undesired plant.

The present invention also refers to a system for applying electrical current into a plant comprising: at least two support structures positioned on separate locations of an area to be treated; a horizontal mover positioned on the supporting structures; an applicator movably placed on the horizontal mover and being configured to travel over the area to be treated, the applicator comprising: an image sensor configured to capture image data of the area to be treated and connected to a processor configured to perform a detection method for detecting an undesired plant; an electrode for applying electrical current by contacting the undesired plant; and a vertical mover configured to vertically move the electrode; wherein, when an undesired plant is detected, the horizontal mover moves the applicator horizontally above the undesired plant and/or the vertical mover moves the electrode toward the undesired plant.

Moreover, the present invention refers to an agricultural pivot comprising a system for applying electrical current into a plant.

The present invention also refers to a method for applying electrical current into a plant with a system, comprising the steps of: moving a applicator with a horizontal mover across an area to be treated; obtaining image data from the area to be treated with an image sensor; and upon detecting an undesired plant with the image sensor: moving the applicator over the undesired plant; moving an electrode toward the undesired plant with a vertical mover; and applying electrical current into the undesired plant.

### BRIEF DESCRIPTION OF THE DRAWINGS

The invention is explained in greater detail below on the basis of figures. Shown therein are:

FIG. 1 shows an applicator for applying electrical current into plants according to the present invention.

FIG. 2 shows an embodiment comprising two applicators according to the present invention.

FIG. 3 shows a system according to the present invention.

### DETAILED DESCRIPTION OF THE INVENTION

The following description is based on preferred embodiments of the invention applied to an applicator for applying electrical current into a plant. However, the present invention is not limited to a particular embodiment, as it will be clear for a skilled person.

Generally, the present invention relates to an applicator for applying electrical current into a plant, the applicator being connected to an electrical power source, the applicator comprising: an image sensor configured to capture image data of the area to be treated and connected to a processor configured to perform a detection method for detecting an undesired plant; an electrode for applying electrical current by contacting the undesired plant; and a vertical mover configured to vertically move the electrode; wherein, when an undesired plant is detected, the horizontal mover moves the applicator horizontally above the undesired plant and/or the vertical mover moves the electrode toward the undesired plant.

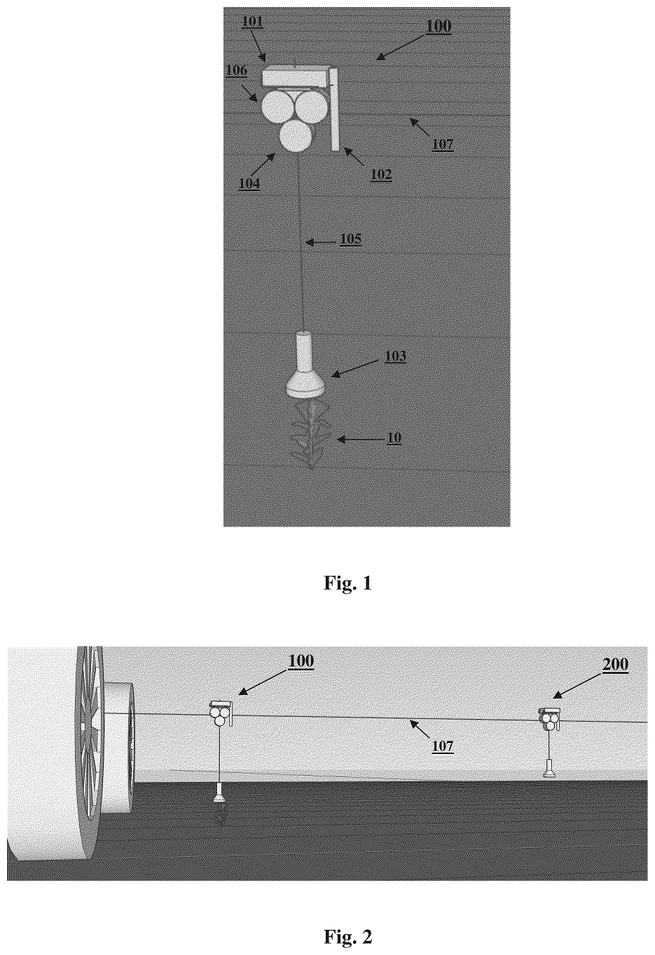

FIG. 1 shows an illustrative embodiment of an applicator 100 for applying electrical current according to the present invention. The applicator is connected to an electrical power source by means of electrical connecting elements such as cables (not shown). In addition, the applicator 100 comprises an electronic controller 101 which can be configured to execute the processing during the operation of the applicator 100.

The applicator 100 comprises an electrode 103 which, as already know from prior art, applies the electrical energy supplied from the electrical source into the unwanted organism. Preferably, the electronic controller 101 is configured to control an electronic converter which configures and adjusts the electrical power supplied by the electrical power source for use in the electrode. Generally, the converter is configured to feed the electrode with electrical energy of a voltage higher than the one fed by the electrical power source.

In this regard, the application of electrical energy into plants, as well the converter and modulation circuits, is widely known from the prior art. For example, document US20200205395A1 describes the dynamic adjustment of current for electrical weeding: instead of application a DC electrical current through power distribution modulation (PDM) and the technology described at US20060265946A1, which modulation is in approximately the same frequency range, wherein Individual Transformer PDM Current Control modulates at the proposed range of from 100 Hz to 10 kHz. This frequency itself, although necessarily smaller than the DC/AC converter (usually a square-wave h-bridge inverter) frequency, is in a much higher range. But unlike proposed by U.S. Pat. No. 10,188,045, where the current adjustment, (generally controlled by PDM or pulse width modulation, PWM)—method described by document US20200205395A1) should be done in relation to soil specificities. Assuming constant or semi-constant voltage and current dynamic adjustments, the current delivered, by the equipment to the purpose of controlling unwanted organisms, should not be in relation to the soil conditions, but should be only limited by the power source. This would ensure the maximum use of the power source, therefore ensuring efficiency of use of the installed control capacity. Therefore, an ideal system should adjust the ideal energy per area to an amount that is sufficient for properly controlling or diminishing the unwanted organisms. For that, it is necessary to consider the use of new constant semi-constant power sources for electrical weeding, such as the one described by US20190320641A1, which allows to use small, cheap, and available electronic components to comprise a high power-factor converter that controls for power without the need of software or other larger components required in previous technological generations. Document WO2019102243A1 presents exemplificative circuits and arrangements for operating electrodes for electrocuting plants. Therefore, as it will be clear for a person skilled in the art, the present invention is not limited to a specific circuit or method of controlling the electrical energy supplied to the electrodes, which must be adjusted according to each application.

As seen in document WO2019052591A1, for the proper functioning of the application of electrical energy into the plants, two electrodes with different polarities must be provided to enable the flow of electrical current upon contact with the plant. Accordingly, the electrical current will flow through the plant's substrate, then, into the soil and return through a ground electrode.

In view of this, in some embodiments, the applicator 100 can be used with one electrode 103 and one or more secondary electrodes for grounding apart from the applicator. Therefore, the applicator 100 can be used in an embodiment comprising a single electrode. Alternatively, the applicator 100 comprises a secondary electrode arranged with a secondary vertical mover (not shown). Hence, both electrodes can be moved wherein the electrode 103 moves toward the undesired plant and the secondary electrode toward the soil surface.

Moreover, the applicator 100 comprises an image sensor 102 for capturing image data and being connected to a processor for performing a method for detecting unwanted plants on the area to be treated. The detection or identification of unwanted organisms, such as weeds, is already known from prior art as seen in documents U.S. Pat. No. 10,548,306B2, WO2017002093A1 and WO2021069980A1. As it will be evident for a skilled person, several techniques can be used for identifying and determining the position and distance of the unwanted plants according to the present invention.

For example, the image sensor 102 can be one of a camera that captures pictures of the area to be treated, wherein the camera can be a combination of any imaging apparatus working at different wavelengths (visible or infrared), with or without spectral filters (multi and/or hyperspectral camera) and with or without 3D capability (stereo vision, time of flight, etc.), scanning devices, laser units, LIDAR, or X-ray cameras.

Preferably, the applicator 100 is able to detect the unwanted organisms with the aid of the image sensor 102 and, for example, imaging methods and object classification. In this context, the classification may be implemented based on the plant morphology. Alternatively, the identification may also be carried out by evaluating data such as the reflectivity at different wavelengths and the classification is thereby made possible on the basis of certain plant characteristics.

In a preferred embodiment, the plant detection is based on a “green/no green” identification system, which basically detects “green” in a given application range with the image sensor. Thus, the system identifies the position of the row of plants and is configured to detect whether a “no green” in the space between the rows. In case no row is detected, the system will perform the detection on the whole width of the vision of the image sensor.

In other preferred embodiment, the system comprises more complex systems that identify a specific plant and in order to identify plants that are different from the plants of the crop planted as seen in documents US20220058770A1 and US20210089771A1 which disclose embodiments of the sensors that are used to identify specific plants for treatments. Therefore, the electrical energy can be applied to all unwanted plants that differ from the plants of the crop.

In addition, the relative position between the electrode 103 and the unwanted plant can also be determined with the aid of the image sensor 102. The determined distance makes it possible to further increase the precision of the weeding process. Since greater uncertainties such as how well the sensor meets its target, the movement of the device, uncertain measurements, the localization of the device for damaging the weed or of the electrode is necessary. For this, some comparable techniques such as scanning by laser may be used. Alternatively, the acquired successive images captured can be processed for determining the distance.

As the image sensor 102 acquires image data during the operation of the weeding applicator 100, the collected data must be processed for the detection and/or classification of unwanted organisms as described above. Such processing can occur in the controller 101, which may function as a processing system for the detection or identification method for targeting the unwanted organism. Alternatively, the controller 101 can be configured to communicate the collected data with a remote computer, which functions as a remote processing system for executing the detection and classification methods and send further instructions to the applicator 101.

Furthermore, the present invention proposes the proper positioning of the applicator 100 for efficiently applying the electrical current into the unwanted organism.

In this regard, in a preferred embodiment, the applicator 100 comprises a vertical mover on which the electrode 103 is attached. Therefore, the invention provides an applicator that can adjust the positioning of the electrode 103 for properly targeting the plant. The vertical mover improves the positioning according to the distance between the electrode 103 and the unwanted plant 10 determined by the image identification method. Preferably, the vertical mover consists of an actuator 104 and an insulating cable 105 for connecting the electrode 103 to the body of the applicator 100. Preferably, the actuator 104 is an electrical motor connected and controlled by the controller 101 with basis on the results obtaining from the image sensor 102 and the information determined by the identification and targeting methods. As seen in the illustrative embodiment, the insulating cable 105 is in an extended position for applying the electrical current to the undesired plant 10. After such operation, the actuator 104 is activated and the electrode 103 can be pulled back, that is, moved toward the body of applicator 100 in order to avoid unwanted contact with any other surface.

In an alternative embodiment, the applicators may comprise automated robot arms as vertical movers, which are attached to the applicator's body and supporting the electrodes. Hence, upon detection of the unwanted plants, the robot arm can be moved toward for applying electrocuting the plant.

Moreover, the applicator 100 can also be configured to travel horizontally across the area to be treated. As it can be seen, the applicator 100 is supported on a horizontal mover 107. Preferably, the horizontal mover 107 is an insulating cable disposed and installed between at least two supporting structures and supporting the applicator 100 so that it can travel on both directions. In this case, the applicator 100 comprises a second actuator 106 configured to be movably supported on the horizontal mover 107 and, when activated, enables the movement of the applicator 100 on both directions of the horizontal mover 107.

Alternatively, actuators can be installed in the supporting structures for moving the horizontal mover 107 and the applicator 100, in this case being fixedly attached, is carried across the area to be treated. Alternatively, the horizontal mover 107 can be a track or guide rail horizontally placed and supported above the ground enabling the movement of the applicator 100 across the crop field.

Still, the embodiment wherein the applicator 100 comprises a second actuator 106 is preferred because it enables simultaneous use of more than one applicator. As seen in FIG. 2, the horizontal mover 106 supports two applicators 100 and 200. The applicator 100 shown with the electrode 103 displaced for contacting the undesired plant, while the electrode of the applicator 200 is retracted. This configuration is useful because increases the number of unwanted plants that can be affected during operation. As it will be clear, the present invention is not limited to the illustrative embodiment described since a plurality of applicators can be used in order to increase the coverage and productivity of the system. Still, it should be noted that more than one horizontal mover 107 can be installed on the structures 301 and 302, thus, enabling the operation of more applicators simultaneously. In an other embodiment, the applicators may be embodied as tethered drones that support the electrode and are connected to the pivot structures comprising the electrical energy source and controller. In addition, the image sensor is supported on the drone and configured for detecting unwanted plants. Consequently, the tethered drone travels over the area to be treated while the area is analyzed via the image sensor. Upon detecting an unwanted plant, the drone moves toward the plant. this embodiment is advantageous since the drone

Preferably, the applicators 100 and 200 comprise presence detection sensors for identifying each other in order to avoid collision or optimizing horizontal distribution on the system.

Therefore, the present invention provides an applicator device that is capable of applying electrical energy into plants comprising an electrode that can be moved upon the detection of unwanted plants.

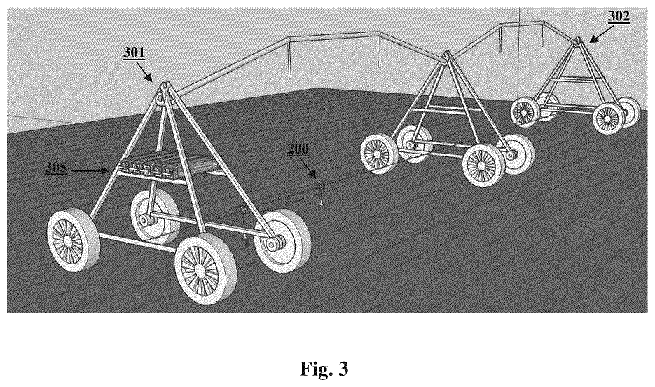

Furthermore, the present invention also refers to a system as shown in FIG. 3. The system comprises at least two supporting structures 301 and 302 positioned on separate locations of an area to be treated. The structures 301 and 302 can be installed for the purposed of weeding or can be part of equipment that is already used in the crop fields.

Preferably, the structures of an agricultural irrigation pivot are used since it can carry the applicators over wide areas of the crop field. In addition, the power modules 305 of the agricultural pivot, positioned on the supporting structure 301, can be used to supply the applicators.

Moreover, on the supporting structures 301 and 302, at least one horizontal mover 107 is positioned, wherein two applicators 100 and 200, as described with reference to FIGS. 1 and 2, are placed.

Thus, when the agricultural irrigation pivots are not functioning with the purposes of irrigating the crop, the structures can be used for carrying the electric weeding devices across the area to be treated. Agricultural irrigation pivots can be disposed in a linear or a radial arrangement, which in both situations cover a large area of a crop field.

Moreover, typically agricultural pivots are formed by large structures whose wheels can be spaced apart from 30 to 40 from each other. Therefore, it could be difficult to reach all undesired plants along on the area to be treated with the system for applying electrical current into undesired plants. In order to overcome this issue, the agricultural pivot can be moved in a slower speed in order to increase the chances of contact of the applicators with the undesired plants. Alternatively, an additional linear horizontal mover may be provided, wherein the additional linear horizontal mover is configured to move in opposite direction of the movement of the pivot structure in order to increase the time of contact with the undesired plant.

Furthermore, the present invention also refers to a method for applying electrical current into a plant with a system. Firstly, the method comprises the step of moving an applicator 100 with the horizontal mover 107 across an area to be treated.

As seen in FIG. 3, the applicators 100 and 200 are moved by the horizontal movers. As the applicators 100 and 200 are moved, the image sensor 102 continuously collects image data in order to detect unwanted plants. Therefore, the method further comprises obtaining image data from the area to be treated with an image sensor 102.

Upon detection of an undesired plant with the image sensor 102, the applicator 100 is moved over the undesired pant 10. In this step, the applicator 100 is moved in order to be directly above the plant to be removed. In addition, the method comprises the step of moving the electrode 103 toward the undesired plant with the vertical mover. Hence, the electrical current can be properly applied into the plant.

Therefore, the present invention solves the technical problem of providing a weeding applicator device that is able to travel over and across an area to be treated in a simple and practical manner and being oriented by image data from the crop field by means of an image sensor. Moreover, the present invention provides and applicator and a system that can be used in equipment that are commonly used in crop fields such as agricultural pivots.

While various example embodiments have been described above, it should be understood that they have been presented by way of example, and not limitation. It will be apparent to persons skilled in the relevant art(s) that various changes in form and detail can be made therein.

1. Applicator for applying electrical current into a plant, the applicator being connected to an electrical power source, the applicator characterized by comprising:
an image sensor configured to capture image data of an area to be treated and connected to a processor configured to perform a detection method for detecting an undesired plant;
at least one active electrode for applying electrical current by contacting the undesired plant; and
a vertical mover configured to vertically move the electrode;
wherein, when an undesired plant is detected, the vertical mover moves the electrode toward the undesired plant.

2. Applicator according to claim 1, further comprising an electronic controller for operating the applicator.

3. Applicator according to claim 1, further comprising an electronic converter for converting the electrical power supplied by the electrical power source, wherein the voltage of the converted electrical energy is higher than the voltage of the electrical power source and its power is regulated through an input from the electronic controller, considering variables of the detected undesired plant.

4. Applicator according to claim 1, comprising a secondary electrode for grounding.

5. Applicator according to claim 4, wherein the secondary electrode is attached to a secondary vertical mover.

6. Applicator according to claim 1, wherein the applicator is configured to determine the distance between the electrode and the undesired plant.

7. Applicator according to claim 1, wherein the image sensor is a camera that captures pictures of the area to be treated, wherein the camera can be a combination of any imaging apparatus working at different wavelengths, with or without spectral filters and with or without 3D capability, scanning devices, laser units, LIDAR, or X-ray cameras.

8. Applicator according to claim 1, wherein the vertical mover comprises an actuator and an insulating cable, wherein the actuator is an electrical motor.

9. Applicator according to claim 1, further comprising a second actuator configured to be movably supported on a horizontal mover and for moving the applicator on the horizontal mover.

10. Applicator according claim 1, further comprising presence detection sensors for identifying other applicators on the field.

11. System for applying electrical current into a plant characterized by comprising:
at least two support structures positioned on separate locations of an area to be treated;
a horizontal mover positioned on the supporting structures;
an applicator movably placed on the horizontal mover and being configured to travel over the area to be treated, the applicator comprising:
an image sensor configured to capture image data of an area to be treated and connected to a processor configured to perform a detection method for detecting an undesired plant;
an electrode for applying electrical current by contacting the undesired plant; and
a vertical mover configured to vertically move the electrode;
wherein, when an undesired plant is detected, the horizontal mover moves the applicator horizontally above the undesired plant and/or the vertical mover moves the electrode toward the undesired plant.

12. System according to claim 11, further comprising a plurality of horizontal movers positioned on the supporting structures; and
a plurality of applicators positioned on the horizontal mover.

13. System according to claim 12, wherein each applicator comprises presence detection sensors for identifying other applicators of the plurality of applicators.

14. System according to claim 11, wherein the support structures are structures of an agricultural irrigation pivot.

15. Agricultural pivot further comprising a system as defined in claim 11.

16. Method for applying electrical current into a plant with a system as defined in claim 11, the method comprising the steps of:
moving an applicator with a horizontal mover across an area to be treated;
obtaining image data from the area to be treated with an image sensor; and
upon detecting an undesired plant with the image sensor:
moving the applicator over the undesired plant;
moving an electrode toward the undesired plant with a vertical mover; and
applying electrical current into the undesired plant.
